(19) United States
(12) Patent Application Publication
(10) Pub. No.: US 2009/0235600 A1
(43) Pub. Date: Sep. 24, 2009

(54) STONE WORK SIMULATION SYSTEM

(75) Inventors: John Richard Logan, Oxford, MI (US); Thomas J. Baker, Dryden, MI (US)

Correspondence Address: HOWARD & HOWARD ATTORNEYS PLLC, 450 West Fourth Street, Royal Oak, MI, 48067, US

(73) Assignee: TAPCO INTERNATIONAL CORPORATION, Wixon, MI (US)

(21) Appl. No.: 12/408,168

(22) Filed: Mar. 20, 2009

Related U.S. Application Data
(60) Provisional application No. 61/038,632, filed on Mar. 21, 2008.

(51) Int. Cl. E04C 2/30; E04C 2/04; E04F 13/14; B28B 1/14

(52) U.S. Cl. 52/314; 264/232

(57) ABSTRACT

A stone work simulation system including panels formed from a cementitious material. The panels of the system can be cast or injection molded from cementitious slurry, including hydraulic cement, or gypsum cement and an optional latex/water mixture. A desired amount of the slurry is added to the mold, the surface of which includes several spaced apart depressions formed therein to closely resemble a pattern of stones at least partially disposed in a mortar matrix. Optionally, the mold can include a number of flat spaces formed between the depressions. Optionally, a reinforcing mesh is also provided in the mold. A colorant can be disposed on the bottom mold surface prior to the introduction of the mesh and the slurry to impart a color pattern to the system. After sufficient curing, the panel is removed from the mold and is ready for immediate use and/or further processing, such as additional surface coloring. In use, the system can be mounted to a building surface, such as a wall, e.g., with a mechanical fastener, adhesive, mortar, cement, and/or the like. To provide distinctiveness to the system, a plurality of individual simulated stones (e.g., that have been formed separately or as a separable unit, e.g., according to the process above) that are sized, shaped, and colored similarly to or differently from the system, can be incorporated onto the flat spaces formed on the system to form a unique finished product and avoid the appearance of the installed system being an arrangement of individual panel units.

### CROSS REFERENCE TO RELATED APPLICATION

The present application claims priority to U.S. Provisional Patent Application Ser. No. 61/038,632, filed Mar. 21, 2008, the disclosure of which is hereby expressly incorporated by reference in its entirety.

### FIELD OF THE INVENTION

The present invention relates to architectural and exterior/interior decorative siding and trim elements, such as stone walls, facings, and facades, and more specifically to architectural and decorative trim elements, such as stone walls, facings, and facades, formed from cementitious slurries, especially those containing gypsum.

### BACKGROUND OF THE INVENTION

Many different modern building designs take advantage of various architectural and decorative siding or trim elements, including stone or brick walls, facings, and facades, for purely aesthetic purposes, e.g., to decorate the interior and/or exterior surfaces. Additional architectural and decorative trim elements can also be used in conjunction with other exterior elements of a building or structure, such as exterior doorways, arches, columns, staircases, fountains, and the like. Furthermore, interior trim elements, such as fireplace surrounds, chimney surrounds, mantle pieces, and the like can incorporate various architectural and decorative trim elements as well.

With respect to conventional stone walls, facings, and facades, they generally include a plurality of natural stone products that have been appropriately shaped or sized to be incorporated in various patterns onto a surface, either exterior or interior, with various adhesive or mounting materials, such as mortar or cement. This process is typically very expensive, labor intensive, and time consuming, as the natural stone products must first be sorted and arranged to form a desired pattern, and then carefully and slowly mounted onto the surface with the use of an appropriate material, such as mortar or cement.

The use of “man-made” or synthetic stone products has reduced the cost, labor, and time requirements to install a simulated stone wall, facing, or facade, but in some cases the overall aesthetic appearance of the simulated system is generally not acceptable, particularly those products comprising large panels, each formed to simulate a plurality of stones set in mortar, that are fixed to the wall of a structure (such as a house) in abutting, adjacent relationship with each other. Such a system tends to appear as identical fake-looking repeating units that do not look like a natural stone product. In such systems, the large, individual panels are readily discernable. Even those simulation systems that attempt to accurately recreate the surface appearance and color of natural stone products using preformed panels have not been entirely satisfactory, as they are easily detected, even by laymen, as being a non-natural stone simulation system.

Therefore, it would be advantageous to provide architectural and exterior/interior decorative trim or siding elements, including but not limited to stone work simulation systems, which overcome at least one of the aforementioned problems.

### SUMMARY OF THE INVENTION

One aspect of the present invention provides a stone work simulation system adapted for being mounted to a building structure for replicating the appearance of a natural stone or brick wall. The system includes a plurality of panel units, each being molded of a cementitious material and having a molded face in which an arrangement of natural stones or bricks set in mortar is simulated. Each panel unit molded face is three dimensional, with portions of the replicated natural stones or bricks projecting outwardly from the simulated matrix of mortar in which they have the appearance of being set, each panel unit having a peripheral edge along which its molded face is provided with at least one flat space. Two of these panel units are mountable on the building structure with a flat space of one of the panel units being located adjacent a flat space of the other of the panel units. The system also includes at least one individual simulated natural stone or brick unit adapted for being positioned in overlying, bridged relation to portions of both of the adjacently located flat spaces and being mounted thereto.

Another aspect of the present invention provides a stone work simulation system adapted for being mounted to a building structure, the system including first and second panel units simulating the appearance of a plurality of building material products at least partially disposed in a supporting matrix, the panel units being molded of a cementitious material and having a molded surface, the building material products and supporting matrix being replicated by the molded surfaces. The system also includes the first and second panel units having lateral ends adapted to abuttingly cooperate when the panel units are positioned horizontally adjacent to each other when the stone work simulation system is mounted to the building structure. The abutting cooperation between the horizontally adjacent panel units' lateral ends define a seam between the first and second panel units, the seam extending unbridged in a substantially straight line over the entire vertical height of neither of the first or second horizontally adjacent panel units, whereby the installed stone work simulation system avoids the appearance of being an arrangement of individual panel units. In one embodiment of such a stone work simulation system, an individual simulated building material product unit is mountable to the surfaces of the first and second panel units in bridging, overlying relation to the seam, whereby a portion of the seam is bridged by the simulated building material product unit. In another embodiment of such a stone work simulation system, the building material products replicated in the panel units are bricks, and the supporting matrix being replicated in the panel units is a matrix of mortar. The first and second panel units each replicate a plurality of vertically adjacent courses of several bricks, the replicated bricks of two vertically adjacent courses in each panel unit being relatively offset and overlapping, whereby the abuttingly cooperating lateral ends of the horizontally adjacent first and second panel units are configured to replicate the staggered ends of bricks located in the vertically adjacent courses, the seam extending over the vertical height of either panel being substantially nonlinear.

Still another aspect of the present invention provides a process for manufacturing a stone work simulation system, including: providing a first lower mold surface member including a first mold surface having a plurality of depressions separated by interstices, the depressions simulating the shape and texture of portions of building material products to be replicated by panel units of the stone work simulation system; applying a first colorant to the interstices of the first mold surface; applying a second colorant different from the first colorant to the depressions of the first mold surface; placing a fibrous mat of reinforcing material over the first mold surface; introducing a slurry of cementitious material into the first lower mold surface member, the slurry impregnating and encapsulating the mat and filling the first lower mold surface member with slurry to a desired level above the interstices; permitting the slurry to cure, whereby a molded panel unit of the stone work simulation system is formed; separating the molded panel unit from the first lower mold surface member; and repeating the above steps to form another panel unit of the stone work simulation system. The process also includes providing a second lower mold surface member including a second mold surface having a plurality of depressions, the depressions simulating the shape and texture of portions of building material products to be replicated by individual simulated building material product units of the stone work simulation system; applying a third colorant different from the first colorant to the depressions of the second mold surface; introducing a slurry of cementitious material into the second lower mold surface member, the slurry filling the depressions of the second lower mold surface member; permitting the slurry to cure, whereby a plurality of molded individual simulated building material product units of the stone work simulation system are formed; and separating the molded individual simulated building material product units from the second lower mold surface member.

The present invention provides an architectural and/or exterior/interior decorative trim or siding element, such as but not limited to a stone work simulation system, and such as but not limited to simulated stone or brick walls, facings, and facades, comprised of cement or cementitious materials, including those containing gypsum (e.g., calcined gypsum) or hydraulic cement. The stone work simulation system can be mounted to any number of interior or exterior surfaces of a building by any number of methods, including but not limited to mechanical fasteners, adhesives, glues, mortars, cements, grouts, caulks, and/or the like.

Certain embodiments of the system provide a plurality of panel units replicating or simulating the appearance of natural stone set in mortar, the panel units arranged in abutting, adjacent relationship with each other and affixed to the interior or exterior of a structure. The panel units are preferably sized for easy shipping, handling and installation, and to be secured to the structure with, for example, a fastener located at each corner thereof. For example, a panel unit of the inventive system may be two foot square secured to the structure with four screws—one at each corner. Each corner of the panel unit, and perhaps locations along the panel edges, being a substantially flat area void of a simulated stone.

Subsequent to installation of the panel(s), individual stone elements, similar in general size, shape and color to the stones simulated in the panels, are affixed to these flat areas, typically overlying portions of two or more adjacent panels and thus locally bridging portions of the seams between those panels as well as covering the heads of the screws at the abutting corners, and thereby the installed system avoids the appearance of being an arrangement of individual panel units.

Certain other embodiments of the system provide a plurality of units replicating or simulating the appearance of, for example, bricks set in mortar. The brick simulation system may include a plurality of panel units each replicating one or more courses of bricks, each panel being several “bricks” long. If each panel replicates two or more courses, the lateral ends of the panels would be configured to represent the staggered ends of offset, overlapping bricks located in the vertically adjacent courses. The abutting staggered ends of horizontally adjacent brick simulation panels are interfitted and abutted to provide the appearance of continuing the courses of full bricks set in mortar, and thereby the system, when installed, avoids the appearance of being an arrangement of individual panel units. Such panels may, for example, be secured to the interior or exterior structure by fasteners driven through the panels in “mortared” areas between the simulated bricks, a chinking material matching the simulated mortar then being applied over the fastener head to hide it. Alternatively, the brick simulation system may be substantially identical to the above-described system for simulating stone work, with replicated bricks being substituted for the replicated natural stones in a panel having flat areas at locations on the panel at which it is secured, by screws for example, to the underlying structure, with individual brick units then being secured to the flat areas, overlying portions of adjacent panels and bridging portions of seams between the panels and covering the fastener heads.

By way of non-limiting examples, the above-described units of the stone work simulation system (regardless of particular form) can be formed by an open-mold casting process or by a closed-mold injection molding process similar to resin transfer molding, from cementitious slurry comprising gypsum cement (e.g., calcined gypsum) and an optional latex/water mixture, or a hydraulic cement. The slurry can also contain other materials, such as but not limited to reinforcement materials (e.g., fibers), as well as other materials that are known in the art (e.g., activators, set preventers, plasticizers, fillers, and/or the like), which can be added before and/or after the combination of the gypsum and latex/water mixture. Preferably, the casting or injection molding process includes providing a reinforcing mat of woven fiberglass material in the mold, and then introducing the slurry into the mold and impregnating and enveloping the mat with the slurry, which fills the mold. The reinforcing material may alternatively take the form of a mat, scrim, netting, mesh, or the like. Once the slurry has cured, the reinforcing mat captured therein provides the resulting unit with improved strength and integrity and, in the case of the injection molded part, which tends to be rather thin in material cross section, a desirable degree of flexibility that helps to avoid easy breakage. Preferably, the meshed reinforcement material is a continuous strand natural fiberglass mat having a weight of approximately 0.75 ounce per square foot.

With respect to an open mold casting process for forming a panel unit simulating natural stones set in mortar, the reinforcing mat is placed in the mold and an appropriate amount of the cementitious slurry is added onto the mold surface member to a desired depth, the slurry impregnating and enveloping the reinforcing mat. The mold surface can include several spaced apart depressions formed therein to closely resemble a pattern of stones at least partially disposed in a mortar matrix. Preferably, the mold includes flat spaces formed at each corner, and optionally at locations along the panel edges between depressions. The mold surface can include surface features that closely recreate the shape, size, and surface textures of real stone products, e.g., granite block, river rock, slate, sandstone, marble, and/or the like. The open mold surface can alternatively include depressions and features closely recreating the shape, size and surface textures of man-made products, such as bricks and/or the like, or of other building products.

If a color effect is intended to be imparted to the stone work simulation system, a colorant can be applied to the surface (or portions thereof) of the mold surface member before the slurry is added. Alternatively, the colorant can be applied to the stone work simulation system after the molding process. In accordance with still another alternative, the slurry can be provided with a colorant dispersed therein to provide a color effect throughout the slurry. Thus, even if the finished stone work simulation system is chipped or cracked in the future, the color effect will be maintained throughout the depth of the stone work simulation system, obviating the need for color touchups.

The open mold can be vibrated to ensure that the slurry infiltrates the various surfaces of the mold surface and fully encapsulates the impregnated reinforcing mat. After an appropriate curing or drying time, the product, e.g., an individual panel of the stone work simulation system, is removed from the mold and is ready for immediate use and/or further processing, such as but not limited to coloring or painting and/or the like.

With respect to an injection mold process for forming a panel unit simulating natural stones set in mortar, a lower mold surface member, similar to the mold surface member described above in connection with the open mold casting process, and an upper mold surface member or core that substantially matches the configuration of, and is intended to cooperate with, the lower mold surface member and which includes a sprue, are provided. When the mold is closed, with the lower and upper mold surface members assembled, the interfacing surfaces of the lower and upper mold surface members are separated by a distance corresponding to the material thickness of the resulting panel unit, for example, ¼ inch. Prior to closing the mold, the reinforcing mat is overlaid onto the lower mold surface member, preferably with the edges of the mat overlapping and extending beyond the periphery of the lower mold surface member. The upper mold surface member is then fitted onto the lower mold surface member, sandwiching the extending edges of the mat between their interfacing peripheral surfaces. Preferably, at least one edge of the mat is exposed to the ambient environment outside of the closed mold.

A slurry injection nozzle is then inserted into the sprue and an appropriate amount of the cementitious slurry, the delivery of which may be in a timed shot, is then injected into the closed mold. By extending the edges of the mat over the periphery of the mold, and sandwiching it between the assembled upper and lower mold surface members, the mat additionally functions to vent the mold through its thickness of woven fibers during slurry injection, obviating the need to provide vent holes in the mold itself.

As described above, the lower mold surface member can include several spaced apart depressions formed therein to closely resemble a pattern of stones at least partially disposed in a mortar matrix, and the cooperating upper and lower mold surface members can include flat spaces formed at each corner of the mold, and optionally at locations along the panel edges between the depressions in the lower mold surface member and their corresponding core projections in the upper mold surface member. The lower mold surface can include surface features that closely recreate the shape, size, and surface textures of real stone or man-made building products, as described above.

As described above in connection with the open mold casting process, if a color effect is intended to be imparted to the stone work simulation system, a colorant can be applied to the surface (or portions thereof) of the lower mold surface member before the mat is overlaid onto it. Alternatively, the colorant can be applied to the stone work simulation system after the molding process. The slurry can be alternatively provided with a colorant dispersed therein to provide a color effect throughout the slurry, maintaining the color effect throughout the depth of the unit, obviating the need for color touchups if the finished stone work simulation system is chipped or cracked in the future.

By way of a non-limiting example, to provide further distinctiveness to the above-described stone work simulation system comprising molded panel units replicating natural stone or bricks set in a mortar matrix, a plurality of individual simulated stone or brick units (e.g., that have been formed separately or as a separable unit, e.g., according to a process described above) that are generally sized, shaped, and colored substantially similar to those replicated in the panel units, can be incorporated onto the flat spaces formed on the system panel units as described above to form a unique finished product that does not look like an arrangement of panels when installation is complete. A number of variously shaped, individual simulated stone units may be cast in a single lower mold surface member using the open mold casting process described herein. Owing to the relatively small size and thickness of these individual stone units, a reinforcing mat material is not used in producing them. Preferably, too, the reverse surfaces of these individual stone units are substantially flat, facilitating their mounting, as through use of a construction adhesive, to the flat portions of the system panels.

Further areas of applicability of the present invention will become apparent from the detailed description provided hereinafter. It should be understood that the detailed description and specific examples, while indicating preferred embodiments of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a front elevational view of a dwelling having a stone work simulation system mounted thereto, in accordance with an embodiment of the present invention that simulates natural stone set in mortar;

FIG. 2 is a perspective view of a panel unit of the stone work simulation system shown in FIG. 1;

FIG. 3 is a sectional view taken along line 3-3 of FIG. 2, in accordance with the depicted panel unit being formed by an open mold casting process according to the present invention;

FIG. 3A is a sectional view taken along line 3A-3A of FIG. 2, in accordance with the depicted panel unit being formed by an injection molding process according to the present invention;

FIG. 4 is a partial perspective view of a stone work simulation system being installed onto a building;

FIG. 4A is a partial perspective view of chinking material or other suitable material being applied to a seam between adjacent panel units and around the periphery of an individual stone unit in the system shown being installed in FIG. 4;

FIG. 5 a perspective view of a mold surface member for forming the panel unit shown in FIGS. 2 and 3 by an open mold casting process, or a lower mold surface member for forming the panel unit shown in FIGS. 2 and 3A by an injection molding process;

FIG. 6 is an exploded view of the mold surface member of FIG. 5 and a mold retainer support;

FIG. 7 is a perspective view of the mold retainer support of FIG. 6 on a conveyor system;

FIG. 8 is an exploded view of the mold surface member of FIG. 5 and the mold retainer support of FIG. 6 on a conveyor system;

FIG. 9 is an exploded view of the mold surface member and mold retainer support of FIG. 8 on a conveyor system, and a woven mat of reinforcement material;

FIG. 10 is perspective view of the mold surface member, mold retainer support and reinforcement material of FIG. 9, on a conveyor system;

FIG. 11 shows the view FIG. 10, to which a quantity of slurry is being introduced during an open mold casting process, the mold surface depressions and reinforcement mat being shown through the added slurry material;

FIG. 12 shows the view of FIG. 11 after introduction of slurry into the lower mold surface member during the open mold casting process;

FIG. 13 is an exploded view of the slurry/mold surface member combination being removed from the mold retainer support after the slurry has cured subsequent to the open mold casting process;

FIG. 14 is a exploded view of the panel unit of FIGS. 2 and 3 being removed from the mold surface member subsequent to the open mold casting process;

FIG. 15 is a perspective view of a mold surface member for forming various individual stone units by an open mold casting process;

FIG. 16 is an exploded view of the lower mold surface member and mold retainer support of FIG. 8 on a conveyor system, a woven mat of reinforcement material, and an upper mold surface member for forming the panel unit shown in FIGS. 2 and 3A by an injection molding process;

FIG. 17 is a perspective view of the mold assembly of FIG. 16 closed, with the edges of the reinforcement material mat shown extending over the periphery of the lower mold surface member, on a conveyor system;

FIG. 18 is a sectional view taken along line 18-18 of FIG. 17, also showing the injection nozzle insertable into the sprue of the upper mold surface member;

FIG. 19 is a plan view of two interfittable panel units of a stone work simulation system that replicates a brick wall;

FIG. 20 is a sectional view taken along line 20-20 of FIG. 19, in accordance with the depicted panel unit being formed by an open mold casting process according to the present invention; and

FIG. 20A is a sectional view taken along line 20A-20A of FIG. 19, in accordance with the depicted panel unit being formed by an injection molding process according to the present invention.

Corresponding reference characters indicate corresponding parts throughout the several views. While the invention is susceptible to various modifications and alternative forms, specific embodiments thereof are shown by way of example in the drawings and may herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

Moreover, it is to be noted that the Figures are not necessarily drawn to scale and are necessarily not drawn to the same scale. In particular, the scale of some of the elements of the Figures is greatly exaggerated to emphasize characteristics of the elements. Elements shown in more than one Figure that may be similarly configured have been indicated using the same reference numerals.

### DETAILED DESCRIPTION OF THE INVENTION

The following description of the preferred embodiments is merely exemplary in nature and is in no way intended to limit the invention or its uses.

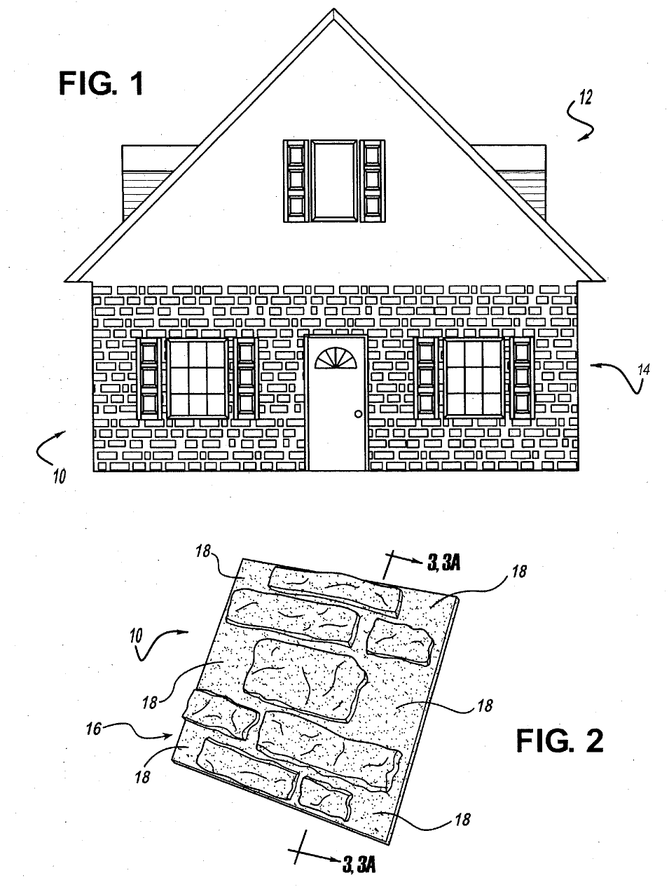

Referring to the Figures generally, and specifically to FIGS. 1-4A, a stone work simulation system is generally disclosed at 10. By “system,” as that term is used herein, it is meant at least one unit of a simulated stone, simulated brick or other simulated building material product. The system can also include one or more units of simulated stone, brick or other building material product or building product produced on a single sheet or sheet-like member, such as a panel. The system can also include one or more individual building product units (e.g., simulated stone units) that are mounted individually to a structure in conjunction with the sheet members. Although the present invention will be described with primary reference to stone work simulation systems, such as but not limited to stone or brick walls, facings, and facades, it should be appreciated that the present invention can be practiced with any type of architectural and exterior/interior decorative trim element, especially those comprised of cementitious material and/or the like.

The stone work simulation system 10 can be mounted to a dwelling or other residential or commercial building. FIG. 1 shows an exterior front view of a house 12 having an exterior wall 14 with a stone work simulation system 10 mounted thereon. The stone work simulation system 10 can be used to cover an entire surface (e.g., an entire wall), or can be used as an accent piece (e.g., a portion of a wall). The stone work simulation system 10 is rigidly secured to the front wall (or any other exterior and/or interior surface) of the house 12 by appropriate securing methods, to be described herein.

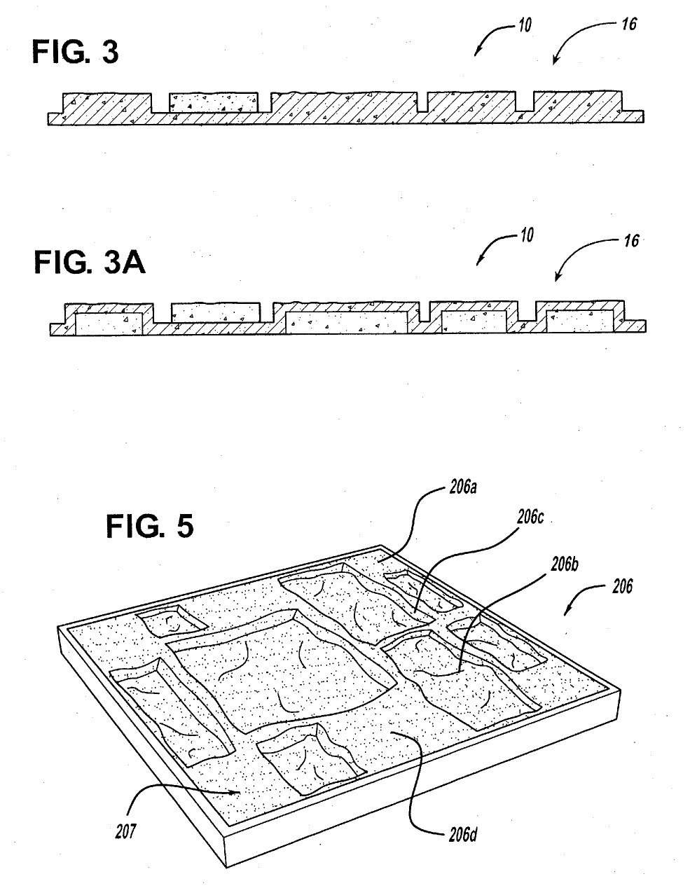

One embodiment of stone work simulation system 10 includes one or more panel units 16, a representative example of which is shown in FIG. 2. Panel units 16 of stone work simulation system may be identical, or of two or more configurations that are varyingly arranged in system 10. Panel units 16 are molded from cementitious material by an open molded casting process, resulting in a panel unit structure generally as illustrated in FIG. 3, or by an injection molding process, resulting in a panel unit structure generally as illustrated in FIG. 3A. More specific details of the panel structure and these alternative processes are further provided herein.

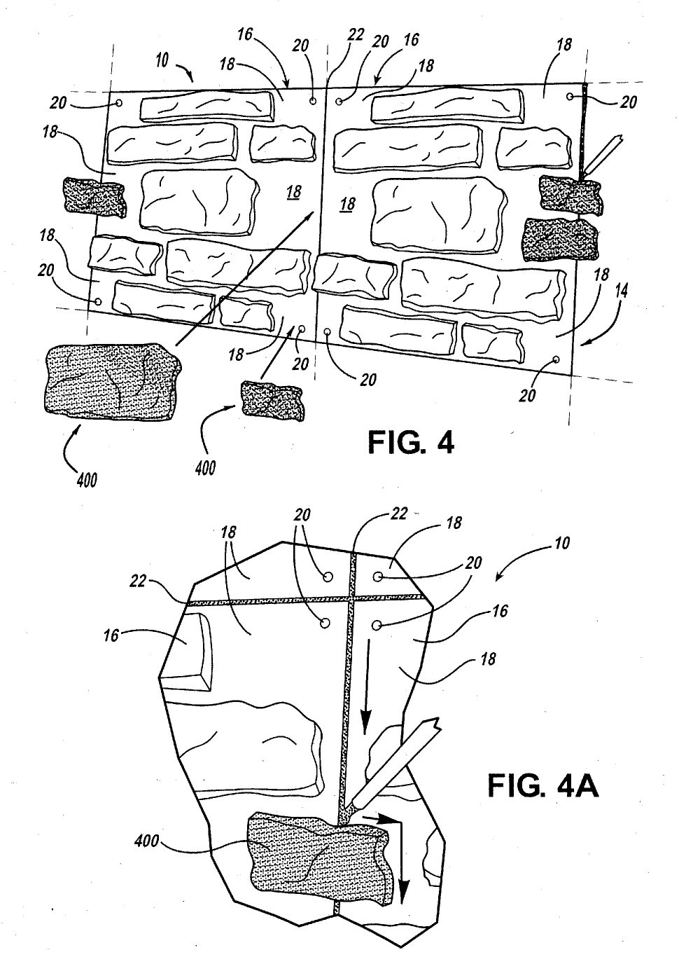

Referring to FIGS. 4-4A, the panel units 16 of stone work simulation system 10 can be mounted to any number of interior or exterior surfaces of a building by any number of methods, including but not limited to mechanical fasteners such as screws 20 as shown, as well as adhesives, glues, mortars, cements, grouts, caulks, and/or the like. The orientation of each individual stone unit 400 of stone work simulation system 10 can be varied with respect to one another so that a random (i.e., non-repeating) appearance is given to the surface having the stone work simulation system 10 applied thereto. Additionally, each individual stone unit 400 of the stone work simulation system 10 can include simulated stones that vary in shape, size and color from those simulated stones of another individual unit 400 of the stone work simulation system 10 in order to further impart a random or more natural stone appearance.

By way of a non-limiting example, to provide further distinctiveness to the stone work simulation system, a plurality of individual simulated stones 400 (e.g., that have been formed separately or as a separable unit, e.g., according to a molding process described herein) that are generally sized, shaped, and colored similarly to or differently from those simulated in the panel units 16 of the system, can be incorporated onto the flat spaces 18 formed on panel units 16 of the stone work simulation system 10 after installation of the panels 16 to form a unique finished product. The individual simulated stones 400 can be mounted onto the stone work simulation system 10 by any number of methods, including but not limited to mechanical fasteners, adhesives, glues, mortars, cements, grouts, caulks, and/or the like. In this manner, the installer can quickly and easily create a simulated stone pattern that is truly unique by consistently varying the size, shape, or color of the individual simulated stones 400 that are being used as accent pieces. Thus, an entire subdivision of houses could have the stone work simulation system 10 applied to an exterior wall thereof with each house having a unique and distinctive appearance.

The individual stone units 400 are preferably placed on the flat spaces 18 of the panel units 16 such that they overlie adjacent, abutting panel units, thereby bridging and hiding portions of the seams 22 between the adjacent panels 16. The individual stone units 400 are also placed over the heads of the fasteners 20, which may each be located at a corner flat space 18 of each panel unit 16, that secure the panel units to the underlying structure, and may also extend over and cover fasteners 20 at adjacent panel corners. Placing the individual stone units 400 in this manner permits the stone work simulation system 10, when installed, to avoid the appearance of being an arrangement of individual panel units.

Further, to hide the seam lines 22 between adjacent panel units 16 of the stone work simulation system 10 or between the individual simulated stone units 400 and flat spaces 18 in the panel units 16 of the stone work simulation system 10, an appropriate cement, grout, caulking, or other suitable material can be applied thereto to cover the seam and simulate a realistic mortar or “chinking” effect that would be seen on real stone walls, facings, or facades. Thus, the appearance to observers would that of a natural stone surface. Preferably, the chinking material matches the color and texture of the mortar being simulated in the panel units.

In accordance with one aspect of the present invention, the cementitious material is formed from cementitious or cement slurry. The slurry can include hydraulic cement including, but not limited to, Portland, sorrel, slag, fly ash, or calcium alumina cement. Additionally, the cement can include a calcium sulfate alpha hemihydrate or calcium sulfate beta hemihydrate. The slurry can also utilize natural, synthetic, or chemically modified beta gypsum or alpha gypsum cement. The cementitious slurry preferably includes gypsum cement and a sufficient amount of water added thereto to produce a slurry having the desired consistency, i.e., not too dry nor not too watery. In accordance with one aspect of the present invention, the water is present in combination with a latex material, such that the powdered gypsum material is combined with the latex/water mixture to form the cementitious slurry.

Gypsum is a naturally occurring mineral, calcium sulfate dihydrate, CaSO₄.2H₂O (unless otherwise indicated, hereafter, “gypsum” will refer to the dihydrate form of calcium sulfate). After being mined, the raw gypsum is thermally processed to form a settable calcium sulfate, which can be anhydrous, but more typically is the hemihydrate, CaSO₄^{-1/2}H₂O, e.g., calcined gypsum. For the familiar end uses, the settable calcium sulfate reacts with water to solidify by forming the dihydrate (gypsum). The hemihydrate has two recognized morphologies, alpha and beta hemihydrate. These are selected for various applications based on their physical properties. Upon hydration, alpha hemihydrate is characterized by giving rise to rectangular-sided crystals of gypsum, while beta hemihydrate is characterized by hydrating to produce needle-shaped crystals of gypsum, typically with large aspect ratio. In the present invention, either or both of the alpha or beta forms can be used, depending on the mechanical performance required. The beta form generates less dense microstructures and is preferred for low density products. Alpha hemihydrate could be substituted for beta hemihydrate to increase strength and density or they could be combined to adjust the properties.

The cementitious slurry can also include other additives. The additives can include, without limitation, accelerators and set preventers or retarders to control the setting times of the slurry. For example, appropriate amounts of set preventers or retarders can be added to the mixture to increase the shelf life of the resulting slurry so that it does not cure prematurely. When the slurry to be used in molding operations, a suitable amount of an accelerator can be added to the slurry, either before or after the pouring operation, so as to increase the drying and/or curing rate of the slurry. Suitable accelerators include aluminum sulfate, potassium sulfate, and Terra Alba ground gypsum. Additional additives can be used to produce colored stone work simulation systems 10, such dry powder metallic oxides such as iron and chrome oxide and pre-dispersed pigments used for coloring latex paints.

In accordance with one aspect of the present invention, a reinforcing material can also be disposed within the cementitious slurry, either prior to or after the introduction of the water thereto. The reinforcing material can include, without limitation, fibers, e.g., either chopped or continuous fibers, comprising at least one of polypropylene fibers, polyester fibers, glass fibers, and/or aromatic polyamide fibers. By way of a non-limiting example, the reinforcing material can include a combination of the fibers, such as the polypropylene fibers and the glass fibers or the polyester fibers and the glass fibers or a blend of the polypropylene fibers and the polyester fibers and the glass fibers. If included in the fiber composition, the aromatic polyamide fibers are formed from poly-paraphenylene terephthalamide, which is a nylon-like polymer commercially available as KEVLAR® from DuPont of Wilmington, Del. Of course, aromatic polyamide fibers other than KEVLAR® are suitable for use in the fiber composition of the present invention.

The cementitious slurry can then be mixed, either manually or automatically, so as to adequately combine the various ingredients thereof and optionally can also be agitated, e.g., by a vibrating table, to remove or lessen any air bubbles that formed in the cementitious slurry.

In accordance with one aspect of the present invention, the cementitious slurry includes a gypsum cement material, such as but not limited to calcined gypsum (e.g., calcium sulfate hemihydrate), also commonly referred to as plaster of Paris. One source of a suitable gypsum cement material is readily commercially available from United States Gypsum Company (Chicago, Ill.) and is sold under the brand name HYDROCAL® FGR 95. According to the manufacturer, HYDROCAL® FGR 95 includes more than 95 wt. % plaster of Paris and less than 5 wt. % crystalline silica.

The gypsum cement material should include an approximate 30% consistency rate. That is, for a 10 lb. amount of gypsum cement material, approximately 3 lbs. of water of would be needed to properly activate the gypsum cement material. If a latex/water mixture is being used to create the cementitious slurry, and the mixture contains approximately 50 wt. % latex solids, then approximately 6 lbs. of the latex/water mixture would be needed, as the latex/water mixture only contains approximately 50 wt. % water, the remainder being the latex solids themselves.

In accordance with another aspect of the present invention, the cementitious slurry includes a melamine resin, e.g., in the dry form, which acts as a moisture resistance agent. The melamine resin is present in an amount of about 10% of the weight of the gypsum cement material. For example, if 10 lbs. of gypsum cement material are used, then approximately 1 lb. of the melamine resin would be used. One source of a suitable melamine resin is readily commercially available from Ball Consulting Ltd. (Ambridge, Pa.).

In accordance with still another aspect of the present invention, the cementitious slurry includes a pH adjuster, such as but not limited to ammonium chloride, a crystalline salt, which acts to ensure proper cross-linking of the latex/water mixture with the dry ingredients, especially the melamine resin. The ammonium chloride is present in an amount of about 1% of the weight of the gypsum cement material. For example, if 10 lbs. of gypsum cement material are used, then approximately 0.1 lbs. of the ammonium chloride would be used. One source of a suitable ammonium chloride is readily commercially available from Ball Consulting Ltd. (Ambridge, Pa.).

In accordance with yet another aspect of the present invention, the cementitious slurry includes a filler such as but not limited to fly ash (e.g., cenosphere fly ash), which acts to reduce the overall weight and/or density of the slurry. The fly ash is present in an amount of about 30% of the weight of the gypsum cement material. For example, if 10 lbs. of gypsum cement material are used, then approximately 3 lbs. of the fly ash would be used. One source of a suitable fly ash is readily commercially available from Trelleborg Fillite Ltd. (Runcorn, England).

Several of the wet and/or dry components of the cementitious slurry of the present invention are readily commercially available in kit form from the United States Gypsum Company under the brand name REDI-ROCK®. Additional information regarding several suitable components of the cementitious slurry of the present invention can be found in U.S. Pat. No. 6,805,741, the entire specification of which is expressly incorporated herein by reference.

One or more of the dry ingredients are to be combined with the liquid portion of the cementitious slurry, i.e., the latex/water mixture. If the latex/water mixture includes 50 wt. % latex solids, with the rest being water, then the latex/water mixture is present in an amount of about 60% of the weight of the gypsum cement material. For example, if 10 lbs. of gypsum cement material are used, then approximately 6 lbs. of the latex/water mixture would be used. One source of a suitable latex/water mixture is readily commercially available from Ball Consulting Ltd. (Ambridge, Pa.) under the brand name FORTON® VF-812. According to the manufacturer, FORTON® VF-812 is a specially formulated, all acrylic co-polymer (50% solids) which crosslinks with a dry resin to make the system moisture resistant and UV stable.

The resulting cementitious slurry of the present invention should possess the following attributes: (1) it should stay wet or flowable for as long as possible, e.g., days, weeks, months, as circumstances warrant; (2) it should self level, i.e., the slurry should level by itself without intervention from the user when introduced into or onto a mold face surface; and (3) it should contain a limited water content (e.g., compared to conventional gypsum cement slurries), i.e., it should not be so wet so as to take a very long time (e.g., several hours or even days) to dry or cure.

Alternatively, the cementitious slurry can preferably be a mixture of rapidly setting hydraulic cement (not a Portland cement) that may or may not contain fiberglass fillers. RapidSet Construction Cement manufactured by CTS Cement Manufacturing Corp. of Cypress, Calif. (www.RapidSet.com) is an acceptable alternative to the above-discussed Gypsum/Latex material, although it is somewhat more brittle and sets in a short time, necessitating its being mixed in rather small batches that can be quickly used. This hydraulic cement is, however, much cheaper than the Gypsum/Latex mixture, and bonds better to fiberglass.

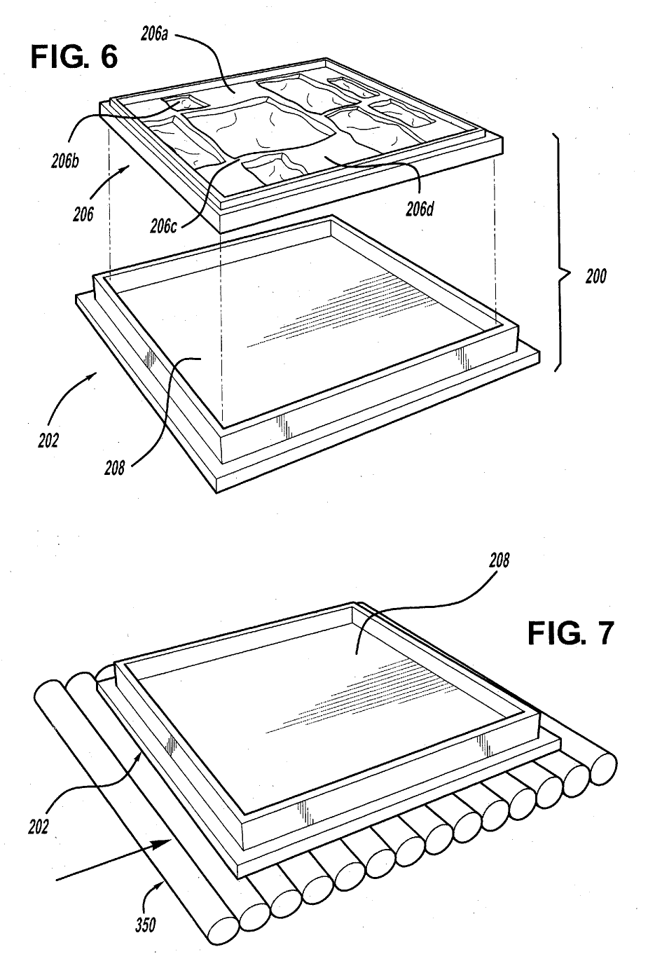

Referring to FIGS. 5-14, one illustrative system and method of forming the panel units 16 of stone work simulation system 10 is open mold casting system 200 used with an open mold casting process. With specific reference to FIGS. 6 and 7, the mold system 200 includes a mold retainer support 202. A lower mold surface member 206 is preferably disposed within a cavity 208 formed in the mold retainer support 202. Although the mold retainer support 202 is shown as being an open shell having a substantially rectangular or square configuration, the mold retainer support 202 can have any number of various configurations. The mold surface member 206 can be formed of any type of material, such as rigid or flexible materials; however, preferably the mold surface member 206 is formed from a suitably flexible material that can be removed from the cavity 208 and which has desirable release properties (e.g., rubber, silicone, urethane and/or the like). The face 206a of the mold surface member 206 is essentially a negative image of the desired front and/or side exterior surface shape of the stones replicated in the panel units 16 of stone work simulation system 10. The mold surface member 206 can include surface features that are able to closely recreate the shape, size, and surface textures of real stone products, e.g., granite block, river rock, slate, sandstone, marble, and/or the like, as well as man-made products, such as bricks and/or the like.

The mold surface member 206 includes several spaced apart depressions 206b formed therein to closely resemble a pattern of stones at least partially disposed in a mortar matrix, recreated by interstices 206c formed around the depressions 206b. Certain embodiments of mold surface member 206 include a number of flat spaces 206d formed between the depressions 206b and/or along one or more edges of the mold surface member, and/or at each corner of the mold surface member 206, mold flat spaces 206d provided to form flat spaces 18 in molded panel units 16, the intended purpose of which is described above. In accordance with another embodiment, the mold surface member 206 can be formed so as not to have any flat spaces, i.e., the mold surface member includes several closely spaced depressions with little space in between adjacent depressions. Such a mold surface member embodiment may be preferably employed in molding panel units replicating portions of a brick wall, as discussed further herein below.

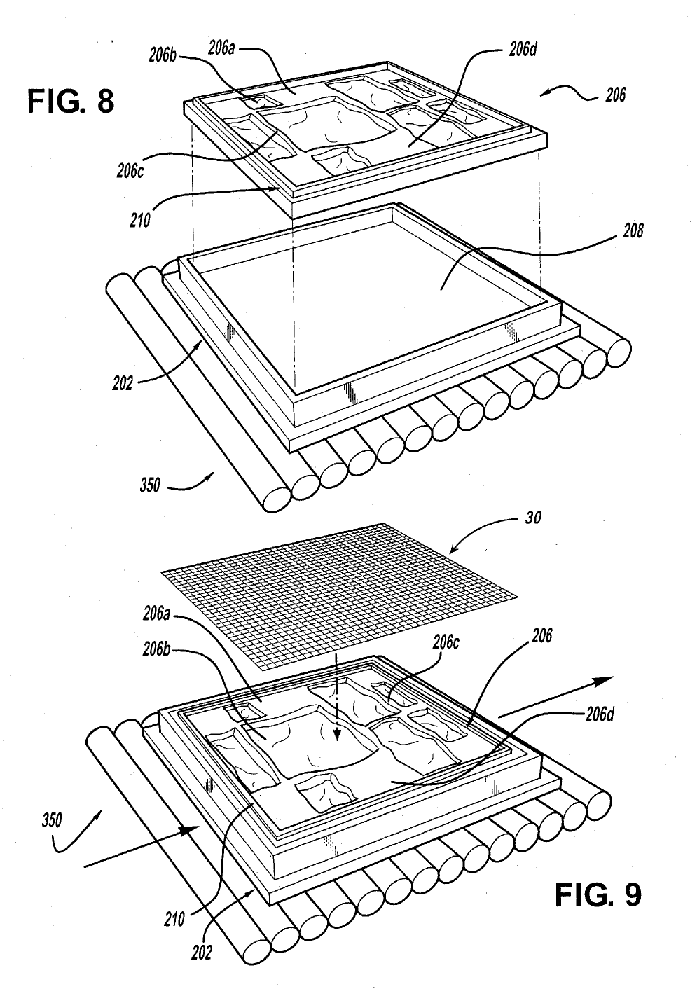

Additionally, the mold surface member 206 preferably includes a peripheral lip member 210 (FIGS. 8-10) to aid in grasping the mold surface member 206, e.g., when it is desired to remove the mold surface member 206 from the cavity 208.

Because of the weights involved of the various mold components, as well as the cementitious slurry, a transport device, such as a conveyor system 350 (e.g., see FIGS. 8-13), either manually or automatically operated, can be employed to guide the mold system 200 along during the manufacturing process, e.g., from an initial processing station, to a curing station, and finally to a product removal station. In this manner, many stone work simulation system panel units 16 can be produced sequentially and rapidly (e.g., in an assembly line process) without having to wait for each individual panel unit 16 to be finally and completely manufactured.

If a color effect is intended to be imparted to the stone work simulation system 10, then, after mold surface member 206 is placed in mold retainer support 202 (FIG. 6 or 8) one or more colorants 207 (FIG. 5) such as, for example, latex-based paints, can be applied to the surface (or portions thereof) 206a of the mold surface member 206 before the slurry is added to the mold. The colorant in contact with mold surface 206a is that which will be visible in the resulting product. For example, colorant for the mortar simulated in the panel unit 16 could first be applied (e.g., rolled) to mold interstices 206c and flat spaces 206d, and colorant(s) for the stone surfaces replicated in the panel unit then applied (e.g., sprayed) onto the mold surface, particularly within mold depressions 206b. Any stone colorant that covers the mortar colorant previously applied to interstices 206c and flat spaces 206d will not be visible in the finished panel unit. Alternatively, but less preferably, one or more colorants for the surfaces of the simulated stone surfaces replicated in the panel unit 16 is first applied (e.g., brushed or sprayed) within mold depressions 206b, being careful not to coat interstices 206c or flat spaces 206d with that colorant, then a different colorant for the simulated mortar is applied (e.g., sprayed or rolled) onto interstices 206c and flat spaces 206d. A meshed reinforcement material 30 is then placed over the mold surface member 206 and the slurry poured into the open mold, while the colorants 207 are either dry or still tacky. The colorants 207 are thus absorbed into or coat the molded slurry surface, and are released from the mold surface member 206 with the panel unit 16 once the slurry cures. Alternatively, colorants 207 can be applied to the finished panel units 16 of stone work simulation system 10 after the molding process.

In accordance with still another alternative, the slurry can be provided with a colorant dispersed therein to provide a color effect throughout the slurry, thus, if the finished stone work simulation system 10 is chipped or cracked in the future, the color effect will be maintained throughout the material depth of the panel unit 16 of stone work simulation system 10, thus lessening or eliminating the future need for color touchups.

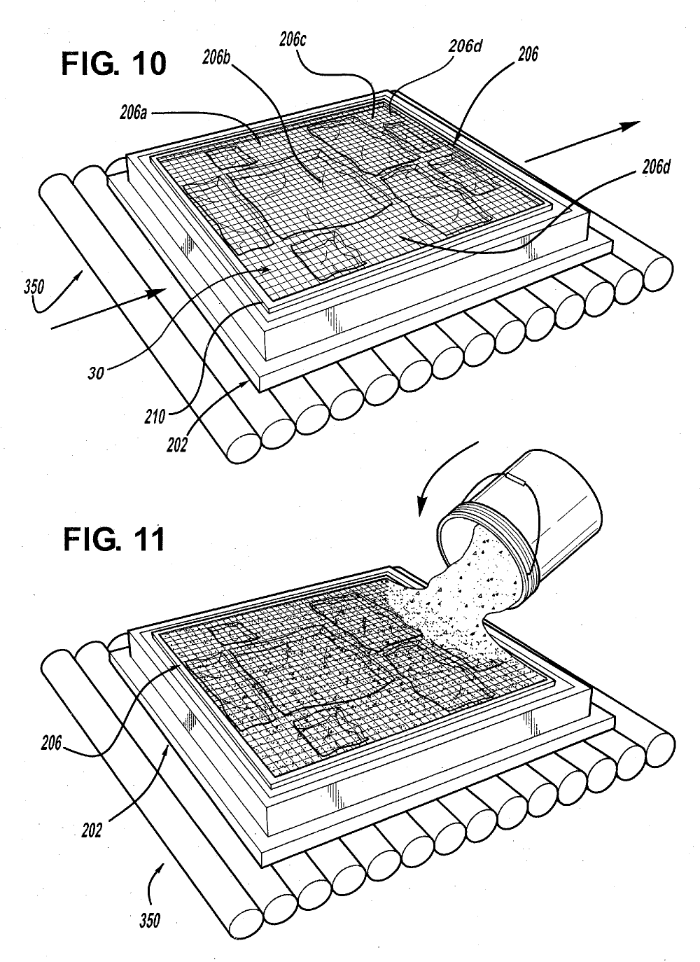

Referring to FIGS. 9 and 10, the reinforcing material mat 30 is placed over and covers substantially all of mold face 206a subsequent to any pre-molding colorant application process. The cementitious slurry, prepared as described above, and preferably when still wet, is then sprayed or poured into the mold surface member 206, either manually or mechanically, such that it contacts and fills the mold surface member 206 to a desired depth, flowing through and impregnating the reinforcing mat 30, encapsulating it, as shown in FIGS. 11 and 12. The amount of the cementitious slurry could be added on the basis of weight, as opposed to volume. However, it should be appreciated that either less than or more than this amount (e.g., volume and/or weight) of the cementitious slurry can be used, e.g., depending on the specific application. Optionally, a vibratory force can be applied to the mold system 200, e.g., to remove any residual air bubbles in the cementitious slurry.

Panel units 16 molded in accordance with the above described open mold casting process generally have a cross section as shown in FIG. 3, which provides a flat reverse surface for ease of mounting. Optionally, an upper or top mold surface member (not shown) can be used with casting system 200 to ensure that the panel units 16 of stone work simulation system 10 formed by this process have a flat reverse surface. It should be noted that such an upper or top mold surface member (not shown) would not typically include a mold face per se that functions as a core and imparts a surface feature into the reverse side of the final product, but rather would be used to assist in the molding process itself.

The cementitious slurry is then allowed to dry, harden or cure for a sufficient amount of time, which may depend, at least in part, on the specific composition of the cementitious slurry used. The mold system 200 can also be shuttled off of the conveyor system 350 and stored in a storage area (not shown) so that other stone work simulation system panel units 16 can be made in the interim.

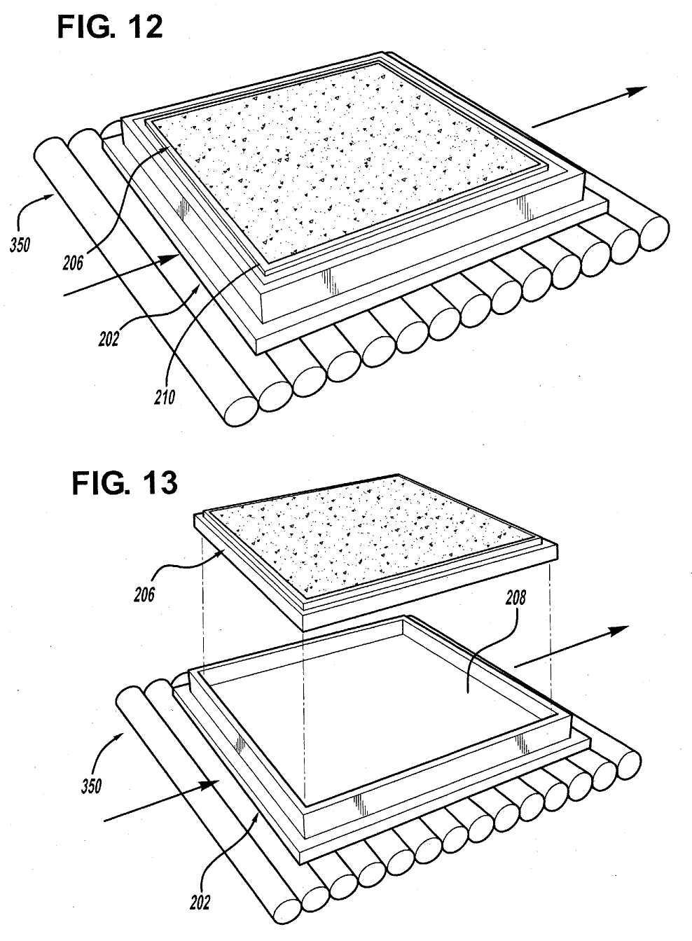

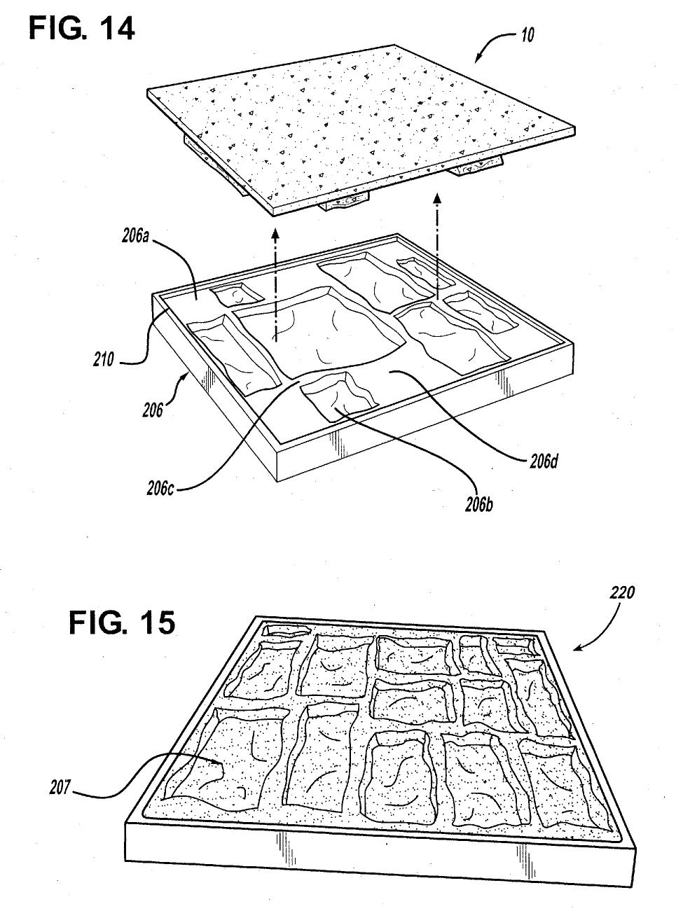

Referring to FIG. 13, once the cementitious slurry has dried, hardened or cured, mold surface member 206 and the molded panel unit 16 of stone work simulation system 10 is removed from the mold retainer support 202. The mold surface member 206 can be removed from the cavity 208 by grapping the peripheral lip member 210 and lifting the mold surface member 206 upwardly and out of the cavity 208. The mold surface member 206 is then removed from the molded panel unit 16 of stone work simulation system 10 as shown in FIG. 14, thus exposing the finished product, which is preferably allowed to dry to a suitable extent, after which time it can then be used immediately or further processed, e.g., painted or otherwise treated.

Referring to FIG. 15, there is shown mold surface member 220 having a mold face including depressions of a variety of sizes and shapes, for molding individual stone units 400 to be used with panel units 16 simulating a natural stone set in mortar. Mold surface member 220 may be placed in mold retainer support 202 and individual stone units 400 molded using the above-described open mold casting system 200 and process, except that reinforcing material 30 need not be used for molding individual stone units 400, and the mold need only be filled with slurry to the tops of the depressions, for no simulated mortared areas are to be formed that interconnect the individual stone units being molded. Individual stone units 400 may be colored in the same manner as the stone surfaces replicated in panel units 16, for example by applying a colorant 207 to the surface of mold surface member 220 prior to introducing the slurry.

Preferably the reverse faces of the individual stone units 400 are flat, to facilitate their mounting, as by an adhesive, to flat spaces 18 on panel units 16, as described above. Therefore, optionally, an upper or top mold surface member (not shown) can be used with molding surface member 220 and casting system 200 to ensure that the individual stone units 400 of stone work simulation system 10 are formed having a flat reverse surface for ease of mounting. As described above, such an upper or top mold surface member (not shown) would not typically include a mold face per se that functions as a core and imparts a surface feature into the reverse side of the final product, but rather would be used to assist in the molding process itself.

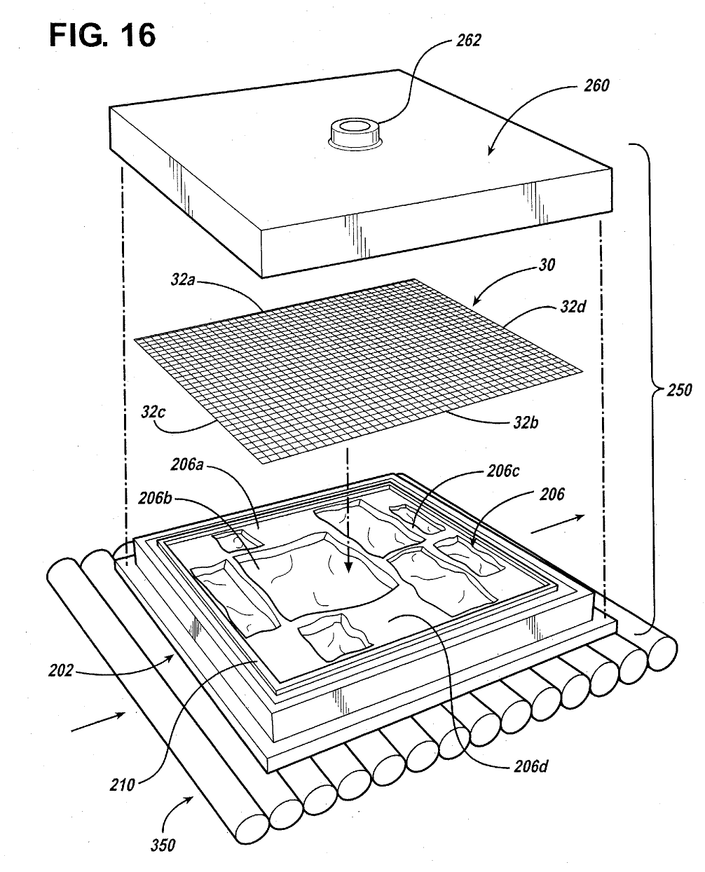

Referring to FIGS. 16-18, another illustrative system and method of forming the panel units 16 of stone work simulation system 10 is injection mold system 250 used with an injection molding process. Like open mold casting system 200, injection molding system 250 includes a mold retainer support 202, and a lower mold surface member 206 preferably disposed within a cavity 208 formed in the mold retainer support 202. Here too, although the mold retainer support 202 is shown as being an open shell having a substantially rectangular or square configuration, the mold retainer support 202 can have any number of various configurations. As above, the lower mold surface member 206 can be formed of any type of material, such as rigid or flexible materials, but is preferably formed from a suitably flexible material that can be removed from the cavity 208 and which has desirable release properties (e.g., rubber, silicone, urethane and/or the like). As described above, the face 206a of the mold surface member 206 is essentially a negative image of the desired front and/or side exterior surface shape of the stones replicated in the panel units 16 of stone work simulation system 10, and can include surface features that are able to closely recreate the shape, size, and surface textures of real stone or man-made products.

Here too, the mold surface member 206 includes several spaced apart depressions 206b formed therein to closely resemble a pattern of stones at least partially disposed in a mortar matrix, recreated by interstices 206c (best shown in FIGS. 5 and 6) formed around the depressions 206b, with certain embodiments of mold surface member 206 including a number of flat spaces 206d as described above. In accordance with another embodiment utilizing the injection molding system 250 and process, the mold surface member 206 can be formed so as not to have any flat spaces, i.e., the mold surface member includes several closely spaced depressions with little space in between adjacent depressions, and may be preferably employed in molding panel units replicating portions of a brick wall, as discussed further herein below.

Peripheral lip member 210 of lower mold surface member 206 facilitates grasping for removal of the mold surface member 206 from the cavity 208. Conveyor system 350 may be advantageously used as described above with injection molding system 250.

If a color effect is intended to be imparted to the stone work simulation system 10, the same processes applicable to open mold casting system 200 and its process, are likewise applicable to injection molding system 250 and its process.

Reinforcing material mat 30 is placed over and covers mold face 206a subsequent to any pre-molding colorant application process. Preferably, edges 32a-32d of mat 30 extend well beyond the periphery of lower mold surface 206, for reasons explained further below.

Injection molding system 250 further includes upper mold surface member 260 that is placed over and cooperates with lower mold surface member 206 to close the interior of the mold. Preferably, upper mold surface member 260 is formed of the same material as lower mold surface member 206. Upper mold surface member 260 includes sprue 262 in fluid communication with the interior of the closed mold, and which receives injector nozzle 270 insertable by an operator for delivering and injected quantity of the cementitious slurry into the mold cavity. The slurry injected into the mold may be a predetermined volume, or an amount corresponding with a timed shot of slurry into the mold cavity.

The upper mold surface member 260 has an interior mold surface, best seen in FIG. 18, which corresponds to and cooperates with the configuration of lower mold surface 206a. The distance between the interfacing surfaces of the upper and lower mold surfaces defines the material thickness of panel unit 16 formed using injection molding system 250, e.g., ¼ inch.

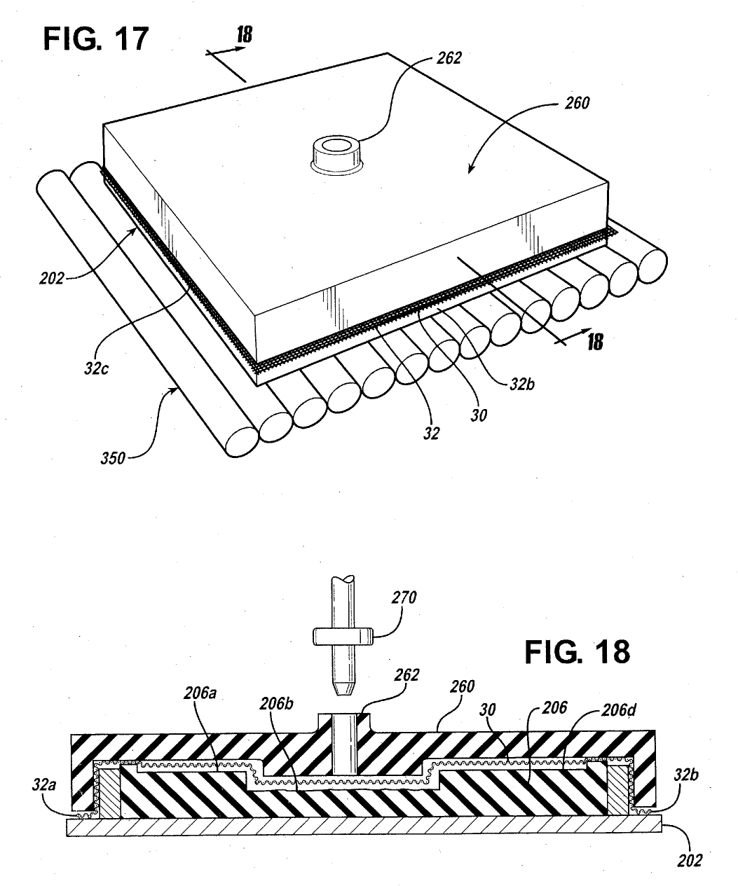

Referring to FIGS. 17 and 18, it can be seen that the periphery 32 of reinforcing mat 30 overlaps lower mold surface member 206, preferably with its edges 32a-32d being exposed to the ambient environment outside of the closed mold. The periphery of mat 30 is sandwiched between the interfacing peripheral surfaces of lower and upper mold surface members 206, 260, and mat 30 thereby provides the mold cavity with a vent during the injection of slurry into the closed mold. Thus, it is not necessary to provide a separate vent in the mold through which air displaced by the injected slurry, as well as a small portion of the injected slurry, may be expelled from the mold to ensure proper and complete cavity filling.

The cementitious slurry is then allowed to dry, harden or cure for a sufficient amount of time, which may depend, at least in part, on the specific composition of the cementitious slurry used. The mold system 250 can also be shuttled off of the conveyor system 350 and stored in a storage area (not shown) so that other stone work simulation system panel units 16 can be made in the interim.

As with the open mold casting process of system 200, once the injection molded cementitious slurry has dried, hardened or cured, and the upper and lower mold surface members separated, mold surface member 206 and the molded panel unit 16 of stone work simulation system 10 is removed from the mold retainer support 202. The mold surface member 206 can be removed from the cavity 208 by grapping the peripheral lip member 210 and lifting the mold surface member 206 upwardly and out of the cavity 208. The mold surface member 206 is then removed from the molded panel unit 16 of stone work simulation system 10 as described above, thus exposing a panel unit that is preferably allowed to dry to a suitable extent, after which time flash consisting of slurry and peripheral portions of mat 30 are trimmed from the edges of the panel unit. Panel unit 16 may then be used immediately or further processed, e.g., painted or otherwise treated.

Panel units 16 molded in accordance with the above described injection molding process generally have a cross section as shown in FIG. 3A, and are advantageously lighter, less expensive, and more flexible and less prone to breakage vis-à-vis panel units 16 molded in accordance with the above described open mold casting process.

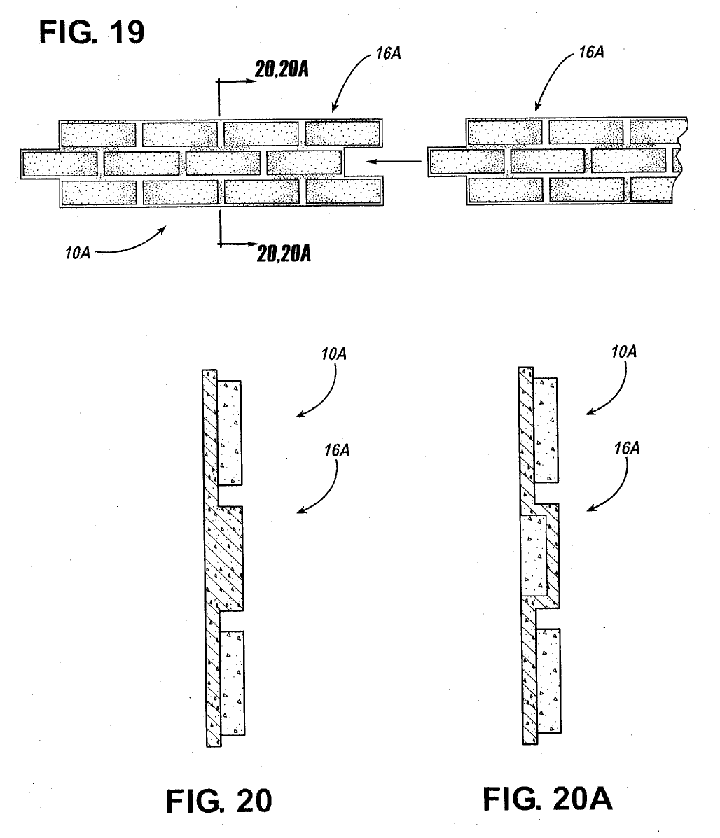

Referring to FIGS. 19-20A, there is shown an embodiment of two interfitting panel units 16A of alternative embodiment stone work simulation system 10A that replicates a brick wall. System 10A simulates the appearance of bricks set in mortar. As depicted, brick simulation system 10A includes one or more panel units 16A, each replicating three courses of bricks, each panel being four “bricks” long, the lateral ends of the panels configured to represent the staggered ends of offset, overlapping bricks located in the vertically adjacent courses.

The abutting staggered ends of adjacent brick simulation panels 16A are interfitted as shown to provide the appearance of continuing the courses of full bricks set in mortar, and thereby system 10A, when installed, avoids the appearance of being an arrangement of individual panel units. Panels 16A may, for example, be secured to the interior or exterior structure by adhesive, or fasteners driven through the panels in “mortared” areas between the simulated bricks, a chinking material matching the simulated mortar then being applied over the fastener head to hide it. Panels 16A of stone work simulation system 10A may be molded by the above-described open mold casting system 200 and casting process, resulting in a panel unit 16A as shown in FIGS. 19 and 20, or by the above-described injection molding system 250 and injection molding process, resulting in a panel unit 16A as shown in FIGS. 19 and 20A.

Alternatively, a brick simulation system may be substantially identical to the above-described system 10 for simulating natural stone work. In such a stone work simulation system 10, replicated bricks are substituted for the above-described replicated natural stones in a panel unit 16 having flat spaces 18 at locations on the panel unit 16 at which it is secured, by screws 20 for example, to the underlying structure, with individual brick units 400 then being secured to the flat spaces 18, overlying portions of adjacent panels 16 and bridging portions of seams 22 between the panels and covering the fastener heads, as described above.

As previously noted, the present invention can be used to produce other architectural and exterior/interior decorative trim elements. Thus, the present invention can produce many different types of architectural and decorative trim elements for use in conjunction with other exterior elements of a building or structure, such as but not limited to exterior doorways, arches, columns, fountains, and the like. Furthermore, the present invention can produce many interior trim elements, such as but not limited to fireplace surrounds, chimney surrounds, mantle pieces, and the like.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A stone work simulation system adapted for being mounted to a building structure for replicating the appearance of a natural stone or brick wall, comprising:
a plurality of panel units, each being molded of a cementitious material and having a molded face in which an arrangement of natural stones or bricks set in mortar is simulated, each said panel unit molded face being three dimensional, with portions of the replicated natural stones or bricks projecting outwardly from the simulated matrix of mortar in which they have the appearance of being set, each said panel unit having a peripheral edge along which its molded face is provided with at least one flat space;
two said panel units being mountable on the building structure with a said flat space of one of said panel units being located adjacent a said flat space of the other of said panel units; and
at least one individual simulated natural stone or brick unit adapted for being positioned in overlying relation to portions of both of said adjacently located flat spaces and being mounted thereto.

2. The stone work simulation system of claim 1, wherein said peripheral edge of each said panel unit is substantially straight, said two panel units being arranged, when mounted to the building structure, such that their substantially straight peripheral edges are adjacent and substantially parallel, a portion of the substantially straight seam being formed between said parallel panel unit edges being bridged by said individual simulated natural stone or brick unit when mounted in its said position overlying portions of both of said adjacently located flat spaces.

3. The stone work simulation system of claim 2, further comprising a chinking material substantially matching the mortar being simulated in the panel units, said chinking material being applied to said seam and about said individual simulated natural stone or brick unit when mounted to said adjacently located flat spaces.

4. The stone work simulation system of claim 1, wherein each said panel unit is substantially rectangular, a said flat space being provided at each of its corners.

5. The stone work simulation system of claim 4, each said panel unit being mountable to the building structure with a fastener driven through said each panel unit within each of its said corner-located flat spaces, a said fastener once driven through said panel unit being covered by said individual simulated natural stone or brick unit.

6. The stone work simulation system of claim 5, a said flat space located at a corner of one of said two panel units being located adjacent a said flat space located at a corner of the other of said panel units when said panel units are mounted to the building structure, said driven fasteners in said adjacent corner-located flat spaces both being covered by said individual simulated natural stone or brick unit when mounted in its said position overlying portions of both of said adjacently located flat spaces.

7. The stone work simulation system of claim 1, further comprising a chinking material substantially matching the mortar being simulated in the panel units, said chinking material being applied between said two panel units after their being mounted to the building structure, and about said individual simulated natural stone or brick unit after its being mounted to said adjacently located flat spaces.

8. The stone work simulation system of claim 1, said cementitious material being formed from cementitious slurry comprising one of gypsum cement and a hydraulic cement.

9. The stone work simulation system of claim 1, wherein said molded panel units each include a reinforcing mat encapsulated by said cementitious material, said panel units being molded by one of an open mold casting process and an injection molded process.

10. The stone work simulation system of claim 9, wherein said molded face of each said panel unit has coating of colorant applied to at least the portions thereof that replicate a mortar matrix.

11. The stone work simulation system of claim 1, wherein said individual simulated natural stone or brick unit is formed with a substantially flat reverse face.

12. A stone work simulation system adapted for being mounted to a building structure, said system comprising:
first and second panel units simulating the appearance of a plurality of building material products at least partially disposed in a supporting matrix, said panel units being molded of a cementitious material and having a molded surface, the building material products and supporting matrix being replicated by said molded surfaces;
said first and second panel units having lateral ends adapted to abuttingly cooperate when said panel units are positioned horizontally adjacent to each other when said stone work simulation system is mounted to the building structure, the abutting cooperation between said horizontally adjacent panel unit lateral ends defining a seam between said first and second panel units, said seam extending unbridged in a substantially straight line over the entire vertical height of neither of said first or second horizontally adjacent panel units, whereby said stone work simulation system when installed avoids the appearance of being an arrangement of individual panel units.

13. The stone work simulation system of claim 12, wherein the building material products replicated in said panel units are one of natural stones and bricks, and the supporting matrix being replicated in said panel units is a matrix of mortar.

14. The stone work simulation system of claim 12, further comprising an individual simulated building material product unit being mountable to said molded surfaces of said first and second panel units in overlying relation to said seam, whereby a portion of said seam is bridged by said simulated building material product unit.

15. The stone work simulation system of claim 14, wherein said molded surfaces of said first and second panel units include flat spaces located along their respective lateral ends, said flat spaces being substantially aligned across said seam, said individual simulated building material product unit being mountable to said substantially aligned flat spaces.

16. The stone work simulation system of claim 15, further comprising a chinking material substantially matching the supporting matrix being replicated by said molded surfaces, said chinking material being disposed in said seam and about said simulated building material product unit mounted to said substantially aligned flat spaces.

17. The stone work simulation system of claim 12, wherein the building material products replicated in said panel units are bricks, and the supporting matrix being replicated in said panel units is a matrix of mortar, said first and second panel units each replicating a plurality of vertically adjacent courses of several bricks, the replicated bricks of vertically adjacent courses in each said panel unit being relatively offset and overlapping, whereby said abuttingly cooperating lateral ends of said horizontally adjacent first and second panel units are configured to replicate the staggered ends of bricks located in the vertically adjacent courses.

18. The stone work simulation system of claim 12, further comprising a chinking material substantially matching the supporting matrix being replicated by said molded surfaces, said chinking material being disposed in said seam.

19. A process for manufacturing a stone work simulation system, comprising:
providing a first lower mold surface member including a first mold surface having a plurality of depressions separated by interstices, the depressions simulating the shape and texture of portions of building material products to be replicated by panel units of the stone work simulation system;
applying a first colorant to the interstices of the first mold surface;
applying a second colorant different from the first colorant to the depressions of the first mold surface;
placing a fibrous mat of reinforcing material over the first mold surface;
introducing a slurry of cementitious material into the first lower mold surface member, the slurry impregnating and encapsulating the mat and filling the first lower mold surface member with slurry to a desired level above the interstices;
permitting the slurry to cure, whereby a molded panel unit of the stone work simulation system is formed;
separating the molded panel unit from the first lower mold surface member; and
repeating the above steps to form another panel unit of the stone work simulation system;
providing a second lower mold surface member including a second mold surface having a plurality of depressions, the depressions simulating the shape and texture of portions of building material products to be replicated by individual simulated building material product units of the stone work simulation system;
applying a third colorant different from the first colorant to the depressions of the second mold surface;
introducing a slurry of cementitious material into the second lower mold surface member, the slurry filling the depressions of the second lower mold surface member;
permitting the slurry to cure, whereby a plurality of molded individual simulated building material product units of the stone work simulation system are formed; and
separating the molded individual simulated building material product units from the second lower mold surface member.

20. The process of claim 19, further comprising:
providing an upper mold surface member including a mold surface that corresponds and cooperates with the first lower mold surface member and having a plurality of core projections that extend into the depressions of the first mold surface, and including a sprue;
overlapping the periphery of the first lower mold surface member with the edges of the reinforcing material mat;
assembling the upper mold surface member to the first lower mold surface member, thereby closing the mold cavity and sandwiching the edges of the reinforcing material mat between the interfacing peripheral edges of the upper and first lower mold surface members;
inserting an injection nozzle into the sprue and introducing a desired quantity of the slurry into the closed mold, the mold cavity being vented to the ambient environment through the fibrous thickness of the reinforcing material mat, thereby ensuring the injected slurry completely fills the closed mold cavity;
removing the upper mold surface member from the first lower mold surface member; and
trimming the flash from about the periphery of the injection molded panel unit after it is separated from the first lower mold surface member.
